(19) United States
(12) Patent Application Publication
(10) Pub. No.: US 2026/0111034 A1
(43) Pub. Date: Apr. 23, 2026

(54) METHOD FOR CONTROLLING ROBOT TO MOVE

(71) Applicant: XINGMAI INNOVATION TECHNOLOGY (SUZHOU) CO., LTD., Suzhou (CN)

(72) Inventor: Shilei ZHANG, Suzhou (CN)

(73) Assignee: XINGMAI INNOVATION TECHNOLOGY (SUZHOU) CO., LTD., Suzhou, JS (CN)

(21) Appl. No.: 19/428,102

(22) Filed: Dec. 20, 2025

Related U.S. Application Data
(63) Continuation of application No. PCT/CN2023/117041, filed on Sep. 5, 2023.

(30) Foreign Application Priority Data
Jun. 27, 2023 (CN) 2023107686961

(51) Int. Cl. G05D 1/648; E04H 4/16; G05D 1/622; G05D 105/10; G05D 107/00; G05D 109/30

(52) U.S. Cl. CPC G05D 1/648; E04H 4/1654; G05D 1/622; G05D 2105/10; G05D 2107/29; G05D 2109/38

(57) ABSTRACT

Embodiments of this application provide a method for controlling a robot to move. The method includes: constructing a contour map of a bottom of a target pool based on edge information of the bottom of the target pool; performing path planning on the bottom of the target pool based on the contour map to obtain a planned path for the bottom of the target pool, where the planned path for the bottom of the target pool includes a plurality of round-trip parallel paths, and the planned path for the bottom of the target pool covers the bottom of the target pool; and controlling the robot to move along the planned path and clean the bottom of the target pool in a moving process. According to this application, a problem of low efficiency in manually cleaning a pool can be resolved, and pool cleaning efficiency can be improved.

### CROSS-REFERENCE TO RELATED APPLICATIONS

This application is a continuation of International Patent Application No. PCT/CN2023/117041, filed on Sep. 5, 2023, which claims priority to Chinese Patent Application No. 202310768696.1, filed with the China National Intellectual Property Administration on Jun. 27, 2023 and entitled “METHOD FOR CONTROLLING ROBOT TO MOVE”, which is hereby incorporated by reference herein.

### TECHNICAL FIELD

Embodiments of this application relate to the communication field, and in particular, to a method for controlling a robot to move.

### BACKGROUND

In a related field, a pool is usually cleaned manually. Because the pool is large, manual cleaning needs a lot of human resources, and manual cleaning of the pool is time-consuming and inefficient.

### An Effective Solution to Resolve the Above Problem Has Not Been Proposed.

### SUMMARY

Embodiments of this application provide a method for controlling a robot to move to at least resolve a problem in a related technology of low efficiency in manually cleaning a pool.

According to one embodiment of this application, a method for controlling a robot to move is provided. The method includes: constructing a contour map of a bottom of a target pool based on edge information of the bottom of the target pool; performing path planning on the bottom of the target pool based on the contour map to obtain a planned path for the bottom of the target pool, where the planned path for the bottom of the target pool includes a plurality of round-trip parallel paths, and the planned path for the bottom of the target pool covers the bottom of the target pool; and controlling the robot to move along the planned path and clean the bottom of the target pool in a moving process.

In some embodiments, the performing path planning on the bottom of the target pool based on the contour map to obtain a planned path for the bottom of the target pool includes: determining a shape of the bottom of the target pool based on the contour map; determining a longest side and a shortest side of the bottom of the target pool when the bottom of the target pool is polygonal; and determining a plurality of paths that have a target position relationship with the longest side or the shortest side of the bottom of the target pool as the planned path for the bottom of the target pool. The target position relationship includes a parallel relationship or a perpendicular relationship.

In some embodiments, the determining a plurality of paths that have a target position relationship with the longest side or the shortest side of the bottom of the target pool as the planned path for the bottom of the target pool includes: when a length of the longest side of the bottom of the target pool is greater than or equal to a first preset length threshold, determining a plurality of paths perpendicular to the longest side of the bottom of the target pool as the planned path for the bottom of the target pool; or when a length of the shortest side of the bottom of the target pool is less than or equal to a second preset length threshold, determining a plurality of paths perpendicular to the shortest side of the bottom of the target pool as the planned path for the bottom of the target pool.

In some embodiments, the determining a plurality of paths that have a target position relationship with the longest side or the shortest side of the bottom of the target pool as the planned path for the bottom of the target pool includes: when there is a slope at the bottom of the target pool, determining, based on an ascending direction of the slope, a plurality of paths parallel to the longest side of the bottom of the target pool as the planned path for the bottom of the target pool, determining a plurality of paths parallel to the shortest side of the bottom of the target pool as the planned path for the bottom of the target pool, determining a plurality of paths perpendicular to the longest side of the bottom of the target pool as the planned path for the bottom of the target pool, or determining a plurality of paths perpendicular to the shortest side of the bottom of the target pool as the planned path for the bottom of the target pool.

In some embodiments, the determining, based on an ascending direction of the slope, a plurality of paths parallel to the longest side of the bottom of the target pool as the planned path for the bottom of the target pool, determining a plurality of paths parallel to the shortest side of the bottom of the target pool as the planned path for the bottom of the target pool, determining a plurality of paths perpendicular to the longest side of the bottom of the target pool as the planned path for the bottom of the target pool, or determining a plurality of paths perpendicular to the shortest side of the bottom of the target pool as the planned path for the bottom of the target pool includes: projecting the ascending direction on a plane on which the bottom of the target pool is located to obtain a projected direction corresponding to the ascending direction; and determining, based on an included angle between the projected direction and the longest side or the shortest side of the bottom of the target pool, the plurality of paths parallel to the longest side of the bottom of the target pool as the planned path for the bottom of the target pool, determining the plurality of paths parallel to the shortest side of the bottom of the target pool as the planned path for the bottom of the target pool, determining the plurality of paths perpendicular to the longest side of the bottom of the target pool as the planned path for the bottom of the target pool, or determining the plurality of paths perpendicular to the shortest side of the bottom of the target pool as the planned path for the bottom of the target pool.

In some embodiments, the determining, based on an included angle between the projected direction and the longest side or the shortest side of the bottom of the target pool, the plurality of paths parallel to the longest side of the bottom of the target pool as the planned path for the bottom of the target pool, determining the plurality of paths parallel to the shortest side of the bottom of the target pool as the planned path for the bottom of the target pool, determining the plurality of paths perpendicular to the longest side of the bottom of the target pool as the planned path for the bottom of the target pool, or determining the plurality of paths perpendicular to the shortest side of the bottom of the target pool as the planned path for the bottom of the target pool includes: when the included angle between the projected direction and the longest side is less than or equal to a first preset angle threshold, determining the plurality of paths perpendicular to the longest side as the planned path for the bottom of the target pool, or when the included angle between the projected direction and the longest side is greater than the first preset angle threshold, determining the plurality of paths parallel to the longest side of the bottom of the target pool as the planned path for the bottom of the target pool; or when the included angle between the projected direction and the shortest side is less than or equal to a second preset angle threshold, determining the plurality of paths perpendicular to the shortest side of the bottom of the target pool as the planned path for the bottom of the target pool, or when the included angle between the projected direction and the shortest side is greater than the second preset angle threshold, determining the plurality of paths parallel to the shortest side of the bottom of the target pool as the planned path for the bottom of the target pool.

In some embodiments, the performing path planning on the bottom of the target pool based on the contour map to obtain a planned path for the bottom of the target pool includes: segmenting a connected region from the contour map to obtain a plurality of segmented regions in the contour map; performing path planning on each of the plurality of segmented regions to obtain a planned path for each segmented region, where the planned path for each segmented region includes a plurality of round-trip parallel paths, and the planned path for each segmented region covers the segmented region; and determining a plurality of planned paths corresponding to the plurality of segmented regions as the planned path for the bottom of the target pool.

In some embodiments, the performing path planning on each of the plurality of segmented regions to obtain a planned path for each segmented region includes: performing the following operations on each of the plurality of segmented regions, where a segmented region on which the following operations are performed is referred to as a current segmented region: determining a shape of the current segmented region, where the shape of the current segmented region includes a polygon; and performing path planning on the current segmented region based on the shape of the current segmented region to obtain a planned path for the current segmented region.

In some embodiments, the performing path planning on the current segmented region based on the shape of the current segmented region to obtain a planned path for the current segmented region includes: determining a shape of the bottom of the target pool based on the contour map; when the current segmented region is polygonal, determining a longest side and a shortest side of the current segmented region; and determining a plurality of paths parallel to the longest side of the current segmented region as the planned path for the current segmented region; determining a plurality of paths parallel to the shortest side of the current segmented region as the planned path for the current segmented region; determining a plurality of paths perpendicular to the longest side of the current segmented region as the planned path for the current segmented region; or determining a plurality of paths perpendicular to the shortest side of the current segmented region as the planned path for the current segmented region.

In some embodiments, the performing path planning on the current segmented region based on the shape of the current segmented region to obtain a planned path for the current segmented region includes: when the current segmented region is a circular region or an elliptical region, determining a target diameter of the current segmented region; and determining a plurality of paths parallel to the target diameter as the planned path for the current segmented region.

In some embodiments, the determining a target diameter of the current segmented region includes: when the current segmented region is the circular region, determining any diameter of the circular region as the target diameter; and when the current segmented region is the elliptical region, determining a longest diameter of the elliptical region based on a minimum bounding rectangle of the elliptical region and determining the longest diameter as the target diameter.

In some embodiments, the method further includes: when there is a slope in the current segmented region, projecting an ascending direction of the slope in the current segmented region on a plane on which the bottom of the target pool is located to obtain a projected direction corresponding to the ascending direction, and when an included angle between the projected direction and a longest side of the current segmented region is less than or equal to a third preset angle threshold, determining a plurality of paths perpendicular to the longest side of the current segmented region as the planned path for the current segmented region, or when the included angle between the projected direction and the longest side of the current segmented region is greater than the third preset angle threshold, determining a plurality of paths parallel to the longest side of the current segmented region as the planned path for the current segmented region; or when an included angle between the projected direction and a shortest side of the current segmented region is less than or equal to a fourth preset angle threshold, determining a plurality of paths perpendicular to the shortest side of the current segmented region as the planned path for the current segmented region, or when the included angle between the projected direction and the shortest side of the current segmented region is greater than the fourth preset angle threshold, determining a plurality of paths parallel to the shortest side of the current segmented region as the planned path for the current segmented region.

In some embodiments, a first path and a second path are two adjacent paths in each of the plurality of segmented regions, and the controlling the robot to move along the planned path includes: controlling the robot to move from a starting point of the first path to an ending point of the first path; determining an endpoint of the second path as a starting point of the second path, where the endpoint of the second path is closest to the ending point of the first path; and controlling the robot to move from the ending point of the first path to the starting point of the second path and controlling the robot to move from the starting point of the second path to an ending point of the second path.

In some embodiments, the controlling the robot to move from the ending point of the first path to the starting point of the second path includes: determining a target angle and a target distance based on the ending point of the first path and the starting point of the second path; and when the robot reaches the ending point of the first path, controlling the robot to rotate by the target angle and then move for the target distance to reach the starting point of the second path.

In some embodiments, the performing path planning on the bottom of the target pool based on the contour map to obtain a planned path for the bottom of the target pool includes: when the bottom of the target pool is a circular region or an elliptical region, determining a target diameter of the bottom of the target pool; and determining a plurality of paths parallel to the target diameter as the planned path for the bottom of the target pool.

In some embodiments, the determining a target diameter of the bottom of the target pool includes: when the bottom of the target pool is the circular region, determining any diameter of the circular region as the target diameter; and when the bottom of the target pool is the elliptical region, determining a longest diameter of the elliptical region based on a minimum bounding rectangle of the elliptical region and determining the longest diameter as the target diameter.

In some embodiments, the controlling the robot to move along the planned path includes: when the planned path for the bottom of the target pool is parallel to a longest side of the bottom of the target pool, determining a path closest to the longest side of the bottom of the target pool as a first starting path on which the robot moves, determining an endpoint of the first starting path as a first starting position from which the robot moves, controlling the robot to move from the first starting position until the planned path for the bottom of the target pool is traversed or it is detected that there is an obstacle within a preset range of the robot, and when the planned path for the bottom of the target pool is traversed or it is detected that there is the obstacle within the preset range of the robot, controlling the robot to stop moving; or the controlling the robot to move along the planned path includes: when the planned path for the bottom of the target pool is parallel to a shortest side of the bottom of the target pool, determining a path closest to the shortest side of the bottom of the target pool as a second starting path on which the robot moves, determining an endpoint of the second starting path as a second starting position from which the robot moves, controlling the robot to move from the second starting position until the planned path for the bottom of the target pool is traversed or it is detected that there is an obstacle within a preset range of the robot, and when the planned path for the bottom of the target pool is traversed or it is detected that there is the obstacle within the preset range of the robot, controlling the robot to stop moving.

According to another embodiment of this application, a pool robot is provided and includes: a construction module configured to construct a contour map of a bottom of a target pool based on edge information of the bottom of the target pool; a path planning module configured to perform path planning on the bottom of the target pool based on the contour map to obtain a planned path for the bottom of the target pool, where the planned path for the bottom of the target pool includes a plurality of round-trip parallel paths, and the planned path for the bottom of the target pool covers the bottom of the target pool; and a control module configured to control the robot to move along the planned path and clean the bottom of the target pool in a moving process.

According to still another embodiment of this application, a computer-readable storage medium is further provided. The computer-readable storage medium stores a computer program. When the computer program is run, steps in any one of the method embodiments are performed.

According to still another embodiment of this application, a pool robot is further provided. The pool robot includes a memory and a processor. The memory stores a computer program. The processor is configured to: when executing the computer program, perform steps in any one of the method embodiments.

According to this application, a robot is used to clean a bottom of a pool. A contour map of a bottom of a target pool is constructed based on edge information of the bottom of the target pool, and path planning is performed based on the contour map to obtain a planned path for the bottom of the target pool. Because the planned path for the bottom of the target pool includes a plurality of round-trip parallel paths, and the planned path covers the entire bottom of the target pool, the robot is controlled to move along the planned path and clean the bottom of the target pool in a moving process. In this way, the robot can move along the planned path to clean the bottom of the pool. Therefore, a problem of low efficiency in manually cleaning the pool can be resolved, and pool cleaning efficiency can be improved.

### BRIEF DESCRIPTION OF THE DRAWINGS

FIG. 1 is a block diagram of a hardware structure of a mobile terminal for performing a method for controlling a robot to move according to an embodiment of this application;

FIG. 2 is a flowchart of a method for controlling a robot to move according to an embodiment of this application;

FIG. 3 is a schematic diagram of path planning according to an embodiment of this application;

FIG. 4 is a schematic diagram of path planning according to another embodiment of this application;

FIG. 5 is a schematic diagram of path planning according to another embodiment of this application;

FIG. 6 is a schematic diagram of path planning according to another embodiment of this application;

FIG. 7 is a schematic diagram of path planning according to another embodiment of this application;

FIG. 8 is a schematic diagram of movement of a robot according to an embodiment of this application; and

FIG. 9 is a block diagram of a structure of an apparatus for controlling a robot to move according to an embodiment of this application.

### DETAILED DESCRIPTION

Embodiments of this application are described in detail in the following with reference to the accompanying drawings and embodiments.

It should be noted that in this specification, claims, and the accompanying drawings of this application, the terms “first”, “second”, and the like are intended to distinguish between similar objects but do not necessarily indicate a specific order or sequence.

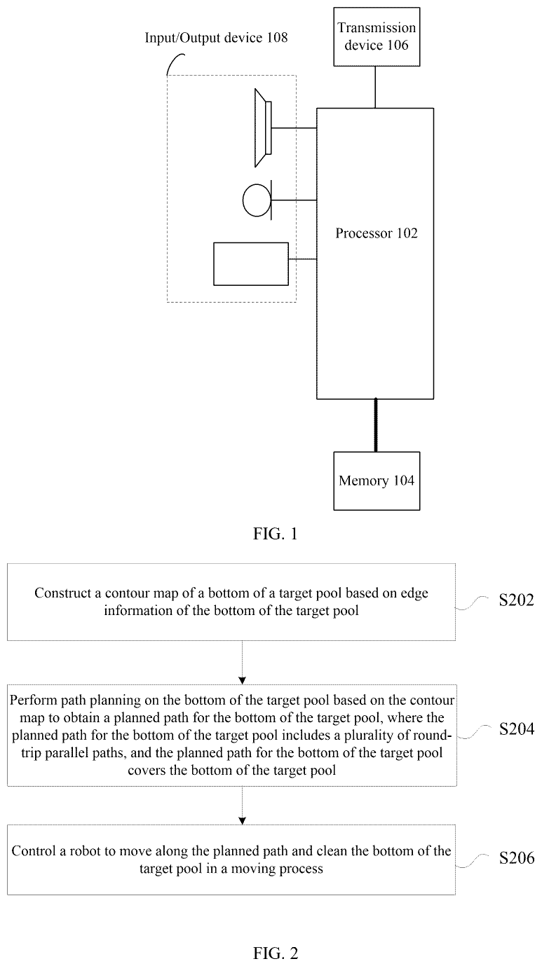

The method provided in embodiments of this application may be performed by a mobile terminal, a computer terminal, or a similar computing apparatus. An example in which the method is performed by the mobile terminal is used. FIG. 1 is a block diagram of a hardware structure of a mobile terminal for performing a method for controlling a robot to move according to an embodiment of this application. As shown in FIG. 1, the mobile terminal may include one or more (only one processor is shown in FIG. 1) processors 102 (the processor 102 may include, but is not limited to, a processing apparatus such as a microprocessor unit MPU or a field-programmable gate array FPGA) and a memory 104 configured to store data. The mobile terminal may further include a transmission device 106 with a communication function and an input/output device 108. A person skilled in the art may understand that the structure shown in FIG. 1 is only an example and does not constitute any limitation on the structure of the mobile terminal. For example, the mobile terminal may alternatively include more or fewer components than those shown in FIG. 1 or have a configuration different from that shown in FIG. 1.

The memory 104 may be configured to store a computer program, for example, a software program of an application software and modules, for example, a computer program corresponding to the method for controlling a robot to move in embodiments of this application. The processor 102 executes the computer program stored in the memory 104 to execute various functional applications and data processing, that is, to implement the above method. The memory 104 may include a high-speed random access memory or a non-volatile memory, for example, one or more magnetic storage apparatuses, a flash memory, or another non-volatile solid-state memory. In some examples, the memory 104 may further include memories that are remotely disposed relative to the processor 102, and these remote memories may be connected to the mobile terminal through a network. Examples of the foregoing network include, but are not limited to, the Internet, an intranet, a local area network, a mobile communication network, and a combination thereof.

The transmission device 106 is configured to receive or send data through a network. Specific examples of the network may include a wireless network provided by a communication provider of the mobile terminal. In one example, the transmission device 106 includes a network interface controller (Network Interface Controller, NIC) and may be connected to other network devices through a base station to communicate with the Internet. In one example, the transmission device 106 may be a radio frequency (Radio Frequency, RF) module configured to communicate with the Internet in a wireless manner.

An embodiment provides a method for controlling a robot to move performed by the above mobile terminal. FIG. 2 is a flowchart of a method for controlling a robot to move according to an embodiment of this application. As shown in FIG. 2, the method may include the following steps.

Step S202: Construct a contour map of a bottom of a target pool based on edge information of the bottom of the target pool.

Step S204: Perform path planning on the bottom of the target pool based on the contour map to obtain a planned path for the bottom of the target pool, where the planned path for the bottom of the target pool includes a plurality of round-trip parallel paths, and the planned path for the bottom of the target pool covers the bottom of the target pool.

Step S206: Control the robot to move along the planned path and clean the bottom of the target pool in a moving process.

In a specific embodiment, the pool may be a swimming pool, and a swimming pool robot may be used to clean the bottom of the swimming pool. Specifically, when the robot sinks to the bottom of the pool, the robot is controlled to rotate around the bottom of the pool by one round to find an edge of the pool. Specifically, a sensor (for example, an ultrasonic sensor) is provided on the robot, and an edge of the pool may be detected based on sensing information collected by the ultrasonic sensor. After the edge of the pool is detected, the robot is controlled to move along the edge of the bottom of the pool. In the moving process of the robot, the sensing information is collected by the sensor provided on the robot (for example, ultrasonic sensing information is collected by the ultrasonic sensor provided on the robot). The contour map of the bottom of the pool is constructed based on the edge information of the bottom of the pool included in the sensing information. Path planning is performed on the bottom of the pool based on the contour map of the bottom of the pool, and the planned path includes a plurality of round-trip parallel paths. The robot may move on the bottom of the pool along the planned path. In the moving process of the robot, a cleaning apparatus provided on the robot may clean the bottom of the pool. Because the path is planned in advance based on the contour map of the bottom of the pool, a motion path of the robot can cover the entire bottom of the pool, and the robot cleans the entire bottom of the pool in a process of moving along the motion path, so that the bottom of the pool can be cleaned more completely.

In some embodiments, the performing path planning on the bottom of the target pool based on the contour map to obtain a planned path for the bottom of the target pool includes: determining a shape of the bottom of the target pool based on the contour map; determining a longest side and a shortest side of the bottom of the target pool when the bottom of the target pool is polygonal; and determining a plurality of paths that have a target position relationship with the longest side or the shortest side of the bottom of the target pool as the planned path for the bottom of the target pool. The target position relationship includes a parallel relationship or a perpendicular relationship. Specifically, a plurality of paths parallel to the longest side of the bottom of the target pool may be determined as the planned path for the bottom of the target pool; or a plurality of paths parallel to the shortest side of the bottom of the target pool may be determined as the planned path for the bottom of the target pool; or a plurality of paths perpendicular to the longest side of the bottom of the target pool may be determined as the planned path for the bottom of the target pool; or a plurality of paths perpendicular to the shortest side of the bottom of the target pool may be determined as the planned path for the bottom of the target pool.

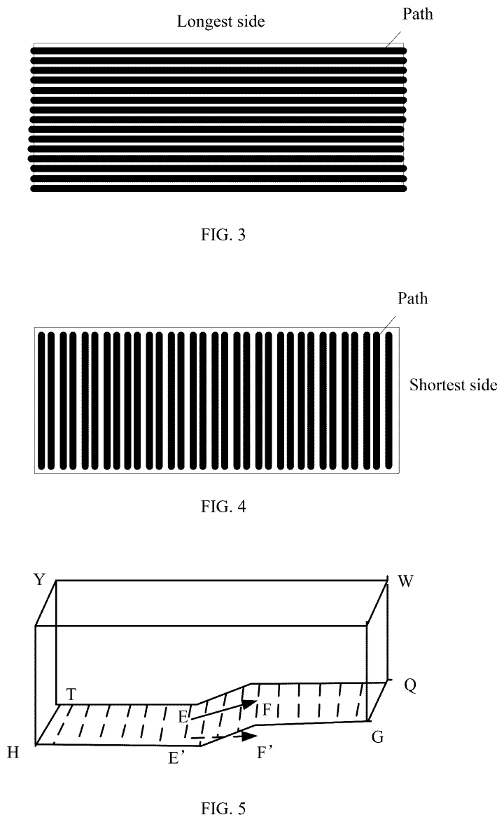

In one specific embodiment, a contour map shown in FIG. 3 is used as an example. A plurality of parallel paths parallel to the longest side are planned on the contour map, and the planned path covers the entire contour map. Alternatively, a contour map shown in FIG. 4 is used as an example. A plurality of parallel paths parallel to the shortest side are planned on the contour map, and the planned path covers the entire contour map. Similarly, a plurality of parallel paths perpendicular to the longest side or the shortest side may alternatively be planned on the contour map. Because the planned path on the contour map covers the entire contour map, the robot may move to various positions at the bottom of the pool when moving along the planned path. A cleaning apparatus is provided on the robot, and the cleaning apparatus cleans the bottom of the pool in the moving process of the robot, so that the bottom of the pool can be cleaned more completely.

In some embodiments, when a length of the longest side of the bottom of the target pool is greater than or equal to a first preset length threshold, a plurality of paths perpendicular to the longest side of the bottom of the target pool are determined as the planned path for the bottom of the target pool; or when a length of the shortest side of the bottom of the target pool is less than or equal to a second preset length threshold, a plurality of paths perpendicular to the shortest side of the bottom of the target pool are determined as the planned path for the bottom of the target pool. The first preset length threshold and the second preset length threshold may be set based on an actual situation.

In one specific embodiment, when the length of the longest side of the bottom of the pool is too large (greater than or equal to the first preset length threshold), if a path is planned to be parallel to the longest side, a moving distance of the robot on one path is too long, which may lead to a deviation in the motion of the robot, affecting a cleaning effect. If a path is planned to be perpendicular to the longest side, a moving distance of the robot on each path may be appropriate. Similarly, when the length of the shortest side is too small (less than or equal to the second preset length threshold), if a path is planned to be parallel to the shortest side, a moving distance of the robot on one path is too short, which may lead to frequent path switching, affecting cleaning efficiency. If a path is planned to be perpendicular to the shortest side, a moving distance of the robot on each path may be appropriate. The length threshold is set, so that the planned path is not too long or too short, thereby achieving a technical effect that a moving distance of the robot on each path is more reasonable.

In some embodiments, when there is a slope at the bottom of the target pool, based on an ascending direction of the slope, a plurality of paths parallel to the longest side of the bottom of the target pool are determined as the planned path for the bottom of the target pool, a plurality of paths parallel to the shortest side of the bottom of the target pool are determined as the planned path for the bottom of the target pool, a plurality of paths perpendicular to the longest side of the bottom of the target pool are determined as the planned path for the bottom of the target pool, or a plurality of paths perpendicular to the shortest side of the bottom of the target pool are determined as the planned path for the bottom of the target pool.

In one specific embodiment, as shown in FIG. 5, there is a slope at the bottom of the target pool, and path planning may be performed based on an ascending direction of the slope (for example, the ascending direction is a direction of EF shown in the figure). A projected direction corresponding to the ascending direction is obtained by projecting the ascending direction on a plane on which the bottom of the target pool is located. For example, a projected direction of E′F′ is obtained by projecting the direction of EF in FIG. 5 on the plane on which the bottom of the target pool is located. Based on an included angle between the projected direction and the longest side or the shortest side of the bottom of the target pool, the plurality of paths parallel to the longest side of the bottom of the target pool may be determined as the planned path for the bottom of the target pool, or the plurality of paths parallel to the shortest side may be determined as the planned path for the bottom of the target pool. The ascending direction of EF in FIG. 5 is parallel to a plane on which Y, W, T, and Q are located, and the projected direction of E′F′ corresponding to the ascending direction of EF is parallel to a projection of the longest side TQ. In this case, the included angle between the projected direction of E′F′ in FIG. 5 and the projection of the longest side is 0°. Therefore, the planned path for the bottom of the target pool shown in the figure is perpendicular to the longest side TQ.

In one specific embodiment, when the included angle between the projected direction and the longest side is less than or equal to a first preset angle threshold, the plurality of paths perpendicular to the longest side are determined as the planned path for the bottom of the target pool, or when the included angle between the projected direction and the longest side is greater than the first preset angle threshold, the plurality of paths parallel to the longest side of the bottom of the target pool are determined as the planned path for the bottom of the target pool; or when the included angle between the projected direction and the shortest side is less than or equal to a second preset angle threshold, the plurality of paths perpendicular to the shortest side of the bottom of the target pool are determined as the planned path for the bottom of the target pool, or when the included angle between the projected direction and the shortest side is greater than the second preset angle threshold, the plurality of paths parallel to the shortest side of the bottom of the target pool are determined as the planned path for the bottom of the target pool.

For example, the first preset angle threshold and the second preset angle threshold may be set based on an actual situation, and the first preset angle threshold and the second preset angle threshold may be equal or unequal. For example, the first preset angle threshold may be 30°, 45°, or the like, and the second preset angle threshold may be 30°, 40°, or the like. The slope shown in FIG. 5 is used as an example. If the included angle between the projected direction of E′F′ corresponding to the ascending direction of the slope and the longest side is 0° which is less than the first preset angle threshold (which is assumed to be 45°), the planned path is perpendicular to the longest side; or if the included angle between the projected direction of E′F′ corresponding to the ascending direction of the slope shown in FIG. 5 and the shortest side is 90° which is greater than the second preset angle threshold (which is assumed to be 40°), the planned path is parallel to the shortest side. In this embodiment, the projected direction corresponding to the ascending direction of the slope is obtained by projecting the ascending direction of the slope on the plane on which the bottom of the target pool is located, and path planning is performed based on the included angle between the projected direction and the longest side or the shortest side. This can reduce an amount of sliding of the robot on the slope and prevent the robot from sliding on the slope.

In some embodiments, the performing path planning on the bottom of the target pool based on the contour map to obtain a planned path for the bottom of the target pool includes: segmenting a connected region from the contour map to obtain a plurality of segmented regions in the contour map; performing path planning on each of the plurality of segmented regions to obtain a planned path for each segmented region, where the planned path for each segmented region includes a plurality of round-trip parallel paths, and the planned path for each segmented region covers the segmented region; and determining a plurality of planned paths corresponding to the plurality of segmented regions as the planned path for the bottom of the target pool. Specifically, the connected region in the contour map is determined, and the connected region is segmented from the contour map to obtain a plurality of segmented regions in the contour map; path planning is performed on each of the plurality of segmented regions to obtain a planned path for each segmented region, where the planned path for each segmented region includes a plurality of round-trip parallel paths, and the planned path for each segmented region covers the segmented region; and the plurality of planned paths corresponding to the plurality of segmented regions are determined as the planned paths for the bottom of the target pool. The connected region generally refers to an image region including foreground pixels that have a same pixel value and are adjacent in an image. Connected component analysis means identifying and labeling each connected region in the image. The contour map may be segmented into a plurality of segmented regions through connected component analysis.

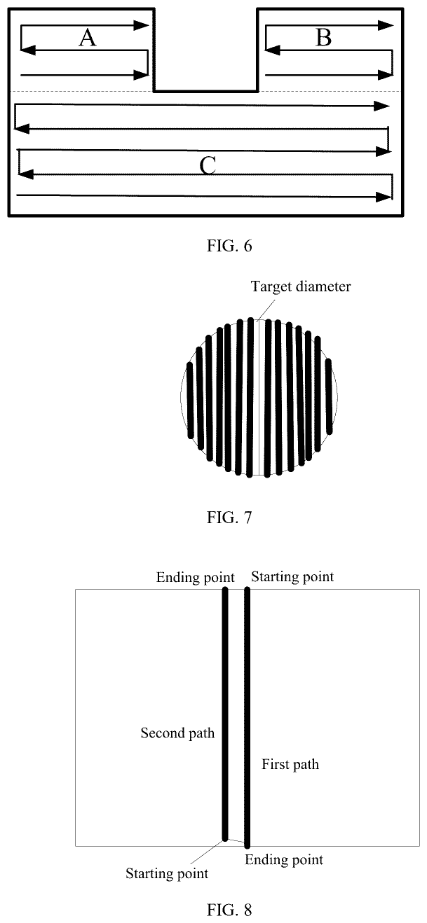

In one specific embodiment, the connected region may be segmented from the contour map through connected component analysis to obtain the plurality of segmented regions in the contour map. The contour map of the bottom of the target pool shown in FIG. 6 is used as an example. Region segmentation is performed on the contour map of the bottom of the target pool shown in the figure. A connected region is considered as a segmented region. The contour map shown in FIG. 6 may be segmented into regions A, B, and C. In this embodiment, because the bottom of the swimming pool in an actual scenario may be of various shapes, the contour map of the bottom of the pool is segmented into a plurality of regions through connected component analysis, and path planning is performed on each segmented region. This can improve path planning efficiency.

For example, the performing path planning on each of the plurality of segmented regions to obtain a planned path for each segmented region includes: performing the following operations on each of the plurality of segmented regions, where a segmented region on which the following operations are performed is referred to as a current segmented region: determining a shape of the current segmented region, where the shape of the current segmented region includes at least one of a polygon, a circle, or an ellipse; and performing path planning on the current segmented region based on the shape of the current segmented region to obtain a planned path for the current segmented region. In the actual scenario, most pools are quadrilateral. In a special case, there is a pool in a shape of a circle, an ellipse, a triangle, a polygon, or the like. Because the contour map is a map of the bottom of the pool, a segmented region obtained by segmenting the contour map may be in a shape of a circle, an ellipse, a triangle, a polygon, or the like.

When the current segmented region is polygonal, a longest side and a shortest side of the current segmented region are determined; and a plurality of paths parallel to the longest side of the current segmented region are determined as the planned path for the current segmented region; a plurality of paths parallel to the shortest side of the current segmented region are determined as the planned path for the bottom of the target pool; a plurality of paths perpendicular to the longest side of the current segmented region are determined as the planned path for the bottom of the target pool; or a plurality of paths perpendicular to the shortest side of the current segmented region are determined as the planned path for the bottom of the target pool.

When there is a slope in the current segmented region, an ascending direction of the slope in the current segmented region is projected on a plane on which the bottom of the target pool is located to obtain a projected direction corresponding to the ascending direction, and when an included angle between the projected direction and a longest side of the current segmented region is less than or equal to a third preset angle threshold, a plurality of paths perpendicular to the longest side of the current segmented region are determined as the planned path for the current segmented region, or when the included angle between the projected direction and the longest side of the current segmented region is greater than the third preset angle threshold, a plurality of paths parallel to the longest side of the current segmented region are determined as the planned path for the bottom of the target pool; or when an included angle between the projected direction and a shortest side of the current segmented region is less than or equal to a fourth preset angle threshold, a plurality of paths perpendicular to the shortest side of the current segmented region are determined as the planned path for the bottom of the target pool, or when the included angle between the projected direction and the shortest side of the current segmented region is greater than the fourth preset angle threshold, a plurality of paths parallel to the shortest side of the current segmented region are determined as the planned path for the bottom of the target pool.

The third preset angle threshold and the fourth preset angle threshold may be set based on an actual situation, and the third preset angle threshold and the fourth preset angle threshold may be equal or unequal. For example, the third preset angle threshold may be 30°, 45°, or the like, and the fourth preset angle threshold may be 30°, 40°, or the like. The projected direction corresponding to the ascending direction of the slope is obtained by projecting the ascending direction of the slope on the plane on which the bottom of the target pool is located, and path planning is performed based on the included angle between the projected direction and the longest side or the shortest side. This can reduce an amount of sliding of the robot on the slope and prevent the robot from sliding on the slope.

Because the segmented region may be in a shape of a circle, an ellipse, a triangle, a polygon, or the like, path planning may be performed based on the shape of the segmented region. Specifically, the following operations are performed on each of the plurality of segmented regions, where a segmented region on which the following operations are performed is referred to as a current segmented region: determining a shape of the current segmented region, where the shape of the segmented region includes a polygon, a circle, and an ellipse, and the polygon includes, but is not limited to, a triangle, a quadrilateral, a pentagon, and the like. Path planning is performed on the current segmented region based on the shape of the current segmented region to obtain a planned path for the current segmented region.

A shape of the bottom of the target pool is determined based on the contour map. When the bottom of the target pool is a circular region or an elliptical region, for example, a circular region shown in FIG. 7, a target diameter of the bottom of the target pool is determined, and a plurality of paths parallel to the target diameter are determined as the planned path for the bottom of the target pool. When the bottom of the target pool is the circular region, any diameter of the circular region may be determined as the target diameter. When the bottom of the target pool is the elliptical region, a longest diameter of the elliptical region is determined based on a minimum bounding rectangle of the elliptical region, and the longest diameter is determined as the target diameter.

Alternatively, when the current segmented region is a circular region or an elliptical region, a target diameter of the current segmented region is determined, and a plurality of paths parallel to the target diameter are determined as the planned path for the current segmented region. When the current segmented region is the circular region, any diameter of the circular region may be determined as the target diameter. When the current segmented region is the elliptical region, a longest diameter of the elliptical region is determined based on a minimum bounding rectangle of the elliptical region, and the longest diameter is determined as the target diameter.

When there is a slope in the current segmented region, a diameter is determined as the target diameter, where an included angle between the diameter and an ascending direction of the slope is less than or equal to a fifth preset angle threshold (which may be set based on an actual situation, for example, 90°). A projected direction corresponding to the ascending direction of the slope is obtained by projecting the ascending direction of the slope on a plane on which the current segmented region is located, and an included angle between the projected direction and the diameter is used as the included angle between the diameter of the current segmented region and the ascending direction of the slope. When the robot moves along a path planned in such a way, an anti-slip effect is the best. A plurality of paths parallel to the target diameter are determined as the planned path for the current segmented region.

In one optional embodiment, when a longest path in the planned path is used as a starting path, the controlling the robot to move along the planned path includes: when the planned path for the bottom of the target pool is parallel to a longest side of the bottom of the target pool, determining a path closest to the longest side of the bottom of the target pool as a first starting path on which the robot moves, determining an endpoint of the first starting path as a first starting position from which the robot moves, controlling the robot to move from the first starting position until the planned path for the bottom of the target pool is traversed or it is detected that there is an obstacle within a preset range of the robot, and when the planned path for the bottom of the target pool is traversed or it is detected that there is the obstacle within the preset range of the robot, controlling the robot to stop moving.

In another optional embodiment, when a shortest path in the planned path is used as a starting path, the controlling the robot to move along the planned path includes: when the planned path for the bottom of the target pool is parallel to a shortest side of the bottom of the target pool, determining a path closest to the shortest side of the bottom of the target pool as a second starting path on which the robot moves, determining an endpoint of the second starting path as a second starting position from which the robot moves, controlling the robot to move from the second starting position until the planned path for the bottom of the target pool is traversed or it is detected that there is an obstacle within a preset range of the robot, and when the planned path for the bottom of the target pool is traversed or it is detected that there is the obstacle within the preset range of the robot, controlling the robot to stop moving.

A first path and a second path are two adjacent paths in each of the plurality of segmented regions. Two paths (the first path and the second path) shown in FIG. 8 are used as an example. The robot is controlled to move from a starting point of the first path to an ending point of the first path; an endpoint of the second path is determined as a starting point of the second path, where the endpoint of the second path is closest to the ending point of the first path; and the robot is controlled to move from the ending point of the first path to the starting point of the second path, and the robot is controlled to move from the starting point of the second path to an ending point of the second path.

The controlling the robot to move from the ending point of the first path to the starting point of the second path includes, but is not limited to, determining a target angle and a target distance based on the ending point of the first path and the starting point of the second path; and when the robot reaches the ending point of the first path, controlling the robot to rotate by the target angle and then move for the target distance to reach the starting point of the second path.

According to the above manner, when the robot moves from a first planned path and starts performing cleaning along the planned path, closed-loop adjustment is performed through, but not limited to, a tracking algorithm, for example, proportion integration differentiation (Proportion Integration Differentiation, PID) and dynamic window approach (Dynamic Window Approach, DWA). The pool shown in FIG. 5 is used as an example. Dashed lines in the figure are the planned path, and the robot is controlled to move along the planned path in a direction from E to F in the figure, to move from an edge TH to an edge QG of the bottom of the pool. EF indicates the slope at the bottom of the pool. When the robot traverses the planned path, cleaning of the bottom is completed.

A manner of cleaning the bottom of the pool by using the robot includes: constructing the contour map of the bottom of the target pool based on the edge information of the bottom of the target pool; performing region segmentation on the contour map to obtain the plurality of segmented regions in the contour map; performing path planning on each of the plurality of segmented region to obtain a planned path for each segmented region; and controlling the robot to move along the planned path. In this way, the robot can move along the planned path to clean the bottom of the pool. Therefore, a problem of low efficiency in manually cleaning the pool can be resolved, and pool cleaning efficiency can be improved.

The above steps may be performed by a terminal, for example, a robot. However, this is not limited thereto.

Based on the foregoing descriptions of the implementations, a person skilled in the art may clearly understand that the method in the above embodiments may be implemented by software in addition to a necessary universal hardware platform or by hardware only. In many cases, the former is a preferred implementation. Based on such understanding, the technical solutions of this application can be essentially or the part that contributes to the related technology can be embodied in a form of a software product. This computer software product is stored in a storage medium (for example, a ROM/RAM, a magnetic disk, or a compact disc), and includes several instructions for instructing a terminal device (which may be a mobile phone, a computer, a server, or a network device) to perform the method described in embodiments of this application.

An embodiment further provides an apparatus for controlling a robot to move. The apparatus is configured to implement the above embodiments and optional implementations. Some that have been described are not described in detail again. The term “module” used below may be a combination of software and/or hardware that implements a preset function. Although the apparatus described in the following embodiment is preferably implemented in software, it may be conceived that the apparatus is implemented in hardware or a combination of software and hardware.

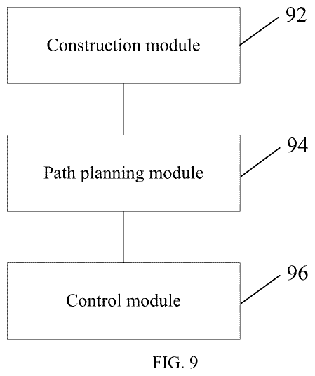

FIG. 9 is a block diagram of a structure of an apparatus for controlling a robot to move according to an embodiment of this application. As shown in FIG. 9, the apparatus includes: a construction module 92 configured to construct a contour map of a bottom of a target pool based on edge information of the bottom of the target pool; a path planning module 94 configured to perform path planning on the bottom of the target pool based on the contour map to obtain a planned path for the bottom of the target pool, where the planned path for the bottom of the target pool includes a plurality of round-trip parallel paths, and the planned path for the bottom of the target pool covers the bottom of the target pool; and a control module 96 configured to control the robot to move along the planned path and clean the bottom of the target pool in a moving process.

In some embodiments, the apparatus is further configured to: determine a shape of the bottom of the target pool based on the contour map; determine a longest side and a shortest side of the bottom of the target pool when the bottom of the target pool is polygonal; and determine a plurality of paths that have a target position relationship with the longest side or the shortest side of the bottom of the target pool as the planned path for the bottom of the target pool. The target position relationship includes a parallel relationship or a perpendicular relationship.

In some embodiments, the apparatus is further configured to: when a length of the longest side of the bottom of the target pool is greater than or equal to a first preset length threshold, determine a plurality of paths perpendicular to the longest side of the bottom of the target pool as the planned path for the bottom of the target pool; or when a length of the shortest side of the bottom of the target pool is less than or equal to a second preset length threshold, determine a plurality of paths perpendicular to the shortest side of the bottom of the target pool as the planned path for the bottom of the target pool.

In some embodiments, the apparatus is further configured to: when there is a slope at the bottom of the target pool, determine, based on an ascending direction of the slope, a plurality of paths parallel to the longest side of the bottom of the target pool as the planned path for the bottom of the target pool, determine a plurality of paths parallel to the shortest side of the bottom of the target pool as the planned path for the bottom of the target pool, determine a plurality of paths perpendicular to the longest side of the bottom of the target pool as the planned path for the bottom of the target pool, or determine a plurality of paths perpendicular to the shortest side of the bottom of the target pool as the planned path for the bottom of the target pool.

In some embodiments, the apparatus is further configured to: project the ascending direction on a plane on which the bottom of the target pool is located to obtain a projected direction corresponding to the ascending direction; and determine, based on an included angle between the projected direction and the longest side or the shortest side of the bottom of the target pool, the plurality of paths parallel to the longest side of the bottom of the target pool as the planned path for the bottom of the target pool, determine the plurality of paths parallel to the shortest side of the bottom of the target pool as the planned path for the bottom of the target pool, determine the plurality of paths perpendicular to the longest side of the bottom of the target pool as the planned path for the bottom of the target pool, or determine the plurality of paths perpendicular to the shortest side of the bottom of the target pool as the planned path for the bottom of the target pool.

In some embodiments, the apparatus is further configured to: when the included angle between the projected direction and the longest side is less than or equal to a first preset angle threshold, determine the plurality of paths perpendicular to the longest side as the planned path for the bottom of the target pool, or when the included angle between the projected direction and the longest side is greater than the first preset angle threshold, determine the plurality of paths parallel to the longest side of the bottom of the target pool as the planned path for the bottom of the target pool; or when the included angle between the projected direction and the shortest side is less than or equal to a second preset angle threshold, determine the plurality of paths perpendicular to the shortest side of the bottom of the target pool as the planned path for the bottom of the target pool, or when the included angle between the projected direction and the shortest side is greater than the second preset angle threshold, determine the plurality of paths parallel to the shortest side of the bottom of the target pool as the planned path for the bottom of the target pool.

In some embodiments, the apparatus is further configured to: segment a connected region from the contour map to obtain a plurality of segmented regions in the contour map; perform path planning on each of the plurality of segmented regions to obtain a planned path for each segmented region, where the planned path for each segmented region includes a plurality of round-trip parallel paths, and the planned path for each segmented region covers the segmented region; and determine a plurality of planned paths corresponding to the plurality of segmented regions as the planned path for the bottom of the target pool.

In some embodiments, the apparatus is further configured to: perform the following operations on each of the plurality of segmented regions, where a segmented region on which the following operations are performed is referred to as a current segmented region: determining a shape of the current segmented region, where the shape of the current segmented region includes a polygon; and performing path planning on the current segmented region based on the shape of the current segmented region to obtain a planned path for the current segmented region.

In some embodiments, the apparatus is further configured to: when the current segmented region is polygonal, determine a longest side and a shortest side of the current segmented region; and determine a plurality of paths parallel to the longest side of the current segmented region as the planned path for the current segmented region; determine a plurality of paths parallel to the shortest side of the current segmented region as the planned path for the current segmented region; determine a plurality of paths perpendicular to the longest side of the current segmented region as the planned path for the current segmented region; or determine a plurality of paths perpendicular to the shortest side of the current segmented region as the planned path for the current segmented region.

In some embodiments, a first path and a second path are two adjacent paths in each of the plurality of segmented regions, and the apparatus is further configured to: control the robot to move from a starting point of the first path to an ending point of the first path; determine an endpoint of the second path as a starting point of the second path, where the endpoint of the second path is closest to the ending point of the first path; and control the robot to move from the ending point of the first path to the starting point of the second path and control the robot to move from the starting point of the second path to an ending point of the second path.

In some embodiments, the apparatus is further configured to: determine a shape of the bottom of the target pool based on the contour map; when the bottom of the target pool is a circular region or an elliptical region, determine a target diameter of the bottom of the target pool; and determine a plurality of paths parallel to the target diameter as the planned path for the bottom of the target pool.

In some embodiments, the apparatus is further configured to: when the planned path for the bottom of the target pool is parallel to a longest side of the bottom of the target pool, determine a path closest to the longest side of the bottom of the target pool as a first starting path on which the robot moves, determine an endpoint of the first starting path as a first starting position from which the robot moves, control the robot to move from the first starting position until the planned path for the bottom of the target pool is traversed or it is detected that there is an obstacle within a preset range of the robot, and when the planned path for the bottom of the target pool is traversed or it is detected that there is the obstacle within the preset range of the robot, control the robot to stop moving; or when the planned path for the bottom of the target pool is parallel to a shortest side of the bottom of the target pool, determine a path closest to the shortest side of the bottom of the target pool as a second starting path on which the robot moves, determine an endpoint of the second starting path as a second starting position from which the robot moves, control the robot to move from the second starting position until the planned path for the bottom of the target pool is traversed or it is detected that there is an obstacle within a preset range of the robot, and when the planned path for the bottom of the target pool is traversed or it is detected that there is the obstacle within the preset range of the robot, control the robot to stop moving.

It should be noted that each module may be implemented by software or hardware, and for the latter, it may be implemented in the following manner: All modules are located in a same processor, or various modules are located in different processors respectively in a form of any combination. However, this is not limited thereto.

An embodiment of this application further provides a computer-readable storage medium. The computer-readable storage medium stores a computer program. When the computer program is run, steps in any one of the method embodiments are performed.

In some embodiments, the computer-readable storage medium may include, but is not limited to, any medium that can store the computer program, for example, a USB flash drive, a read-only memory (Read-Only Memory, ROM), a random access memory (Random Access Memory, RAM), a removable hard disk, a magnetic disk, or a compact disc.

An embodiment of this application further provides a pool robot. The pool robot includes a memory and a processor. The memory stores a computer program. The processor is configured to: when executing the computer program, perform steps in any one of the method embodiments.

In some embodiments, the pool robot may further include a transmission device and an input/output device. The transmission device is connected to the processor, and the input/output device is connected to the processor.

For details of specific examples in this embodiment of this application, refer to the examples described in the above embodiments and example implementations. Details are not described in this embodiment again.

It is clear that a person skilled in the art should understand that the modules or steps in this application may be implemented by a general-purpose computing apparatus, and the modules may be integrated on a single computing apparatus or distributed on a network including a plurality of computing apparatuses, or may be implemented by program code executed by a computing apparatus. In this way, the program code can be stored in a storage apparatus and executed by the computing apparatus. In addition, in some cases, the shown or described steps may be performed in an order different from the above order, or the modules are respectively manufactured into various integrated circuit modules, or a plurality of modules are manufactured into a single integrated circuit module. In this way, this application is not limited to any particular combination of hardware and software.

The foregoing descriptions are merely preferred embodiments of this application, and are not intended to limit this application. For a person skilled in the art, this application may have various modifications and variations. Any modification, equivalent replacement, improvement, or the like made without departing from the principle of this application shall fall within the protection scope of this application.

What is claimed is:

1. A method for controlling a robot to move, comprising:
constructing a contour map of a bottom of a target pool based on edge information of the bottom of the target pool;
performing path planning on the bottom of the target pool based on the contour map to obtain a planned path for the bottom of the target pool, wherein the planned path for the bottom of the target pool comprises a plurality of round-trip parallel paths, and the planned path for the bottom of the target pool covers the bottom of the target pool; and
controlling the robot to move along the planned path and clean the bottom of the target pool in a moving process.

2. The method according to claim 1, wherein the performing path planning on the bottom of the target pool based on the contour map to obtain a planned path for the bottom of the target pool comprises:
determining a shape of the bottom of the target pool based on the contour map;
determining a longest side and a shortest side of the bottom of the target pool when the bottom of the target pool is polygonal; and
determining a plurality of paths that have a target position relationship with the longest side or the shortest side of the bottom of the target pool as the planned path for the bottom of the target pool, wherein the target position relationship comprises a parallel relationship or a perpendicular relationship.

3. The method according to claim 2, wherein the determining a plurality of paths that have a target position relationship with the longest side or the shortest side of the bottom of the target pool as the planned path for the bottom of the target pool comprises:
when a length of the longest side of the bottom of the target pool is greater than or equal to a first preset length threshold, determining a plurality of paths perpendicular to the longest side of the bottom of the target pool as the planned path for the bottom of the target pool; or
when a length of the shortest side of the bottom of the target pool is less than or equal to a second preset length threshold, determining a plurality of paths perpendicular to the shortest side of the bottom of the target pool as the planned path for the bottom of the target pool.

4. The method according to claim 2, wherein the determining a plurality of paths that have a target position relationship with the longest side or the shortest side of the bottom of the target pool as the planned path for the bottom of the target pool comprises:
when there is a slope at the bottom of the target pool, determining, based on an ascending direction of the slope, a plurality of paths parallel to the longest side of the bottom of the target pool as the planned path for the bottom of the target pool, determining a plurality of paths parallel to the shortest side of the bottom of the target pool as the planned path for the bottom of the target pool, determining a plurality of paths perpendicular to the longest side of the bottom of the target pool as the planned path for the bottom of the target pool, or determining a plurality of paths perpendicular to the shortest side of the bottom of the target pool as the planned path for the bottom of the target pool.

5. The method according to claim 4, wherein the determining, based on an ascending direction of the slope, a plurality of paths parallel to the longest side of the bottom of the target pool as the planned path for the bottom of the target pool, determining a plurality of paths parallel to the shortest side of the bottom of the target pool as the planned path for the bottom of the target pool, determining a plurality of paths perpendicular to the longest side of the bottom of the target pool as the planned path for the bottom of the target pool, or determining a plurality of paths perpendicular to the shortest side of the bottom of the target pool as the planned path for the bottom of the target pool comprises:
projecting the ascending direction on a plane on which the bottom of the target pool is located to obtain a projected direction corresponding to the ascending direction; and
determining, based on an included angle between the projected direction and the longest side or the shortest side of the bottom of the target pool, the plurality of paths parallel to the longest side of the bottom of the target pool as the planned path for the bottom of the target pool, determining the plurality of paths parallel to the shortest side of the bottom of the target pool as the planned path for the bottom of the target pool, determining the plurality of paths perpendicular to the longest side of the bottom of the target pool as the planned path for the bottom of the target pool, or determining the plurality of paths perpendicular to the shortest side of the bottom of the target pool as the planned path for the bottom of the target pool.

6. The method according to claim 5, wherein the determining, based on an included angle between the projected direction and the longest side or the shortest side of the bottom of the target pool, the plurality of paths parallel to the longest side of the bottom of the target pool as the planned path for the bottom of the target pool, determining the plurality of paths parallel to the shortest side of the bottom of the target pool as the planned path for the bottom of the target pool, determining the plurality of paths perpendicular to the longest side of the bottom of the target pool as the planned path for the bottom of the target pool, or determining the plurality of paths perpendicular to the shortest side of the bottom of the target pool as the planned path for the bottom of the target pool comprises:
when the included angle between the projected direction and the longest side is less than or equal to a first preset angle threshold, determining the plurality of paths perpendicular to the longest side as the planned path for the bottom of the target pool, or when the included angle between the projected direction and the longest side is greater than the first preset angle threshold, determining the plurality of paths parallel to the longest side of the bottom of the target pool as the planned path for the bottom of the target pool; or
when the included angle between the projected direction and the shortest side is less than or equal to a second preset angle threshold, determining the plurality of paths perpendicular to the shortest side of the bottom of the target pool as the planned path for the bottom of the target pool, or when the included angle between the projected direction and the shortest side is greater than the second preset angle threshold, determining the plurality of paths parallel to the shortest side of the bottom of the target pool as the planned path for the bottom of the target pool.

7. The method according to claim 1, wherein the performing path planning on the bottom of the target pool based on the contour map to obtain a planned path for the bottom of the target pool comprises:
segmenting a connected region from the contour map to obtain a plurality of segmented regions in the contour map;
performing path planning on each of the plurality of segmented regions to obtain a planned path for each segmented region, wherein the planned path for each segmented region comprises a plurality of round-trip parallel paths, and the planned path for each segmented region covers the segmented region; and
determining a plurality of planned paths corresponding to the plurality of segmented regions as the planned path for the bottom of the target pool.

8. The method according to claim 7, wherein the performing path planning on each of the plurality of segmented regions to obtain a planned path for each segmented region comprises:
performing the following operations on each of the plurality of segmented regions, wherein a segmented region on which the following operations are performed is referred to as a current segmented region:
determining a shape of the current segmented region, wherein the shape of the current segmented region comprises a polygon; and
performing path planning on the current segmented region based on the shape of the current segmented region to obtain a planned path for the current segmented region.

9. The method according to claim 8, wherein the performing path planning on the current segmented region based on the shape of the current segmented region to obtain a planned path for the current segmented region comprises:
when the current segmented region is polygonal, determining a longest side and a shortest side of the current segmented region; and
determining a plurality of paths parallel to the longest side of the current segmented region as the planned path for the current segmented region; determining a plurality of paths parallel to the shortest side of the current segmented region as the planned path for the current segmented region;
determining a plurality of paths perpendicular to the longest side of the current segmented region as the planned path for the current segmented region; or determining a plurality of paths perpendicular to the shortest side of the current segmented region as the planned path for the current segmented region.

10. The method according to claim 8, wherein the performing path planning on the current segmented region based on the shape of the current segmented region to obtain a planned path for the current segmented region comprises:
when the current segmented region is a circular region or an elliptical region, determining a target diameter of the current segmented region; and
determining a plurality of paths parallel to the target diameter as the planned path for the current segmented region.

11. The method according to claim 10, wherein the determining a target diameter of the current segmented region comprises:
when the current segmented region is the circular region, determining any diameter of the circular region as the target diameter; and
when the current segmented region is the elliptical region, determining a longest diameter of the elliptical region based on a minimum bounding rectangle of the elliptical region and determining the longest diameter as the target diameter.

12. The method according to claim 8, further comprising:
when there is a slope in the current segmented region, projecting an ascending direction of the slope in the current segmented region on a plane on which the bottom of the target pool is located to obtain a projected direction corresponding to the ascending direction, and when an included angle between the projected direction and a longest side of the current segmented region is less than or equal to a third preset angle threshold, determining a plurality of paths perpendicular to the longest side of the current segmented region as the planned path for the current segmented region, or when the included angle between the projected direction and the longest side of the current segmented region is greater than the third preset angle threshold, determining a plurality of paths parallel to the longest side of the current segmented region as the planned path for the current segmented region; or
when an included angle between the projected direction and a shortest side of the current segmented region is less than or equal to a fourth preset angle threshold, determining a plurality of paths perpendicular to the shortest side of the current segmented region as the planned path for the current segmented region, or when the included angle between the projected direction and the shortest side of the current segmented region is greater than the fourth preset angle threshold, determining a plurality of paths parallel to the shortest side of the current segmented region as the planned path for the current segmented region.

13. The method according to claim 7, wherein a first path and a second path are two adjacent paths in each of the plurality of segmented regions, and the controlling the robot to move along the planned path comprises:
controlling the robot to move from a starting point of the first path to an ending point of the first path;
determining an endpoint of the second path as a starting point of the second path, wherein the endpoint of the second path is closest to the ending point of the first path; and
controlling the robot to move from the ending point of the first path to the starting point of the second path and controlling the robot to move from the starting point of the second path to an ending point of the second path.

14. The method according to claim 13, wherein the controlling the robot to move from the ending point of the first path to the starting point of the second path comprises:
determining a target angle and a target distance based on the ending point of the first path and the starting point of the second path; and
when the robot reaches the ending point of the first path, controlling the robot to rotate by the target angle and then move for the target distance to reach the starting point of the second path.

15. The method according to claim 1, wherein the performing path planning on the bottom of the target pool based on the contour map to obtain a planned path for the bottom of the target pool comprises:
determining a shape of the bottom of the target pool based on the contour map;
when the bottom of the target pool is a circular region or an elliptical region, determining a target diameter of the bottom of the target pool; and
determining a plurality of paths parallel to the target diameter as the planned path for the bottom of the target pool.

16. The method according to claim 15, wherein the determining a target diameter of the bottom of the target pool comprises:
when the bottom of the target pool is the circular region, determining any diameter of the circular region as the target diameter; and
when the bottom of the target pool is the elliptical region, determining a longest diameter of the elliptical region based on a minimum bounding rectangle of the elliptical region and determining the longest diameter as the target diameter.

17. The method according to claim 1, wherein:
the controlling the robot to move along the planned path comprises: when the planned path for the bottom of the target pool is parallel to a longest side of the bottom of the target pool, determining a path closest to the longest side of the bottom of the target pool as a first starting path on which the robot moves, determining an endpoint of the first starting path as a first starting position from which the robot moves, controlling the robot to move from the first starting position until the planned path for the bottom of the target pool is traversed or it is detected that there is an obstacle within a preset range of the robot, and when the planned path for the bottom of the target pool is traversed or it is detected that there is the obstacle within the preset range of the robot, controlling the robot to stop moving; or
the controlling the robot to move along the planned path comprises: when the planned path for the bottom of the target pool is parallel to a shortest side of the bottom of the target pool, determining a path closest to the shortest side of the bottom of the target pool as a second starting path on which the robot moves, determining an endpoint of the second starting path as a second starting position from which the robot moves, controlling the robot to move from the second starting position until the planned path for the bottom of the target pool is traversed or it is detected that there is an obstacle within a preset range of the robot, and when the planned path for the bottom of the target pool is traversed or it is detected that there is the obstacle within the preset range of the robot, controlling the robot to stop moving.

18. A computer-readable storage medium, wherein the computer-readable storage medium stores a computer program, and when the computer program is executed by a processor, steps of the method according to claim 1 are implemented.

19. A swimming pool robot, comprising a memory, a processor, and a computer program that is stored in the memory and that is capable of being run on the processor, wherein when executing the computer program, the processor implements steps of the method according to claim 1.
